(19) United States
(12) Patent Application Publication
(10) Pub. No.: US 2013/0257716 A1
(43) Pub. Date: Oct. 3, 2013

(54) INTERACTIVE INPUT SYSTEM AND METHOD

(71) Applicant: SMART TECHNOLOGIES ULC, Calgary (CA)

(72) Inventors: MIN XIN, Calgary (CA); DOUGLAS BLAIR HILL, Calgary (CA); ALEXANDER GARIN, Calgary (CA)

(73) Assignee: SMART TECHNOLOGIES ULC, Calgary (CA)

(21) Appl. No.: 13/837,483

(22) Filed: Mar. 15, 2013

Related U.S. Application Data
(60) Provisional application No. 61/618,686, filed on Mar. 31, 2012.

(51) Int. Cl. G09G 5/00

(52) U.S. Cl. CPC G09G 5/003
USPC 345/156

(57) ABSTRACT

A method of operating an interactive input system, comprises detecting user interaction with an interactive surface; acquiring schedule information from a scheduler; and transitioning said interactive input system to an operating mode according to at least one of said user interaction and said schedule information.

### CROSS-REFERENCE TO RELATED APPLICATION

This application claims the benefit of U.S. Provisional Application No. 61/618,686 to Xin et al. filed on Mar. 31, 2012, entitled “Interactive Input System and Method”, the entire disclosure of which is incorporated herein by reference.

### FIELD OF THE INVENTION

The present invention relates to an interactive input system and method.

### BACKGROUND OF THE INVENTION

Interactive input systems that allow users to inject input (e.g., digital ink, mouse events etc.) into an application program using an active pointer (e.g., a pointer that emits light, sound, or other signal), a passive pointer (e.g., a finger, cylinder or other suitable object) or other suitable input devices such as for example, a mouse, or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the entire disclosures of which are incorporated by reference; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control application programs executed by the computer.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a finger, pointer, pen tool etc. touches the optical waveguide surface, due to a change in the index of refraction of the optical waveguide at the touch location, causing some light to escape from the optical waveguide at the touch point. In such multi-touch interactive input systems, the machine vision system captures images including light that escapes the optical waveguide, reflects off the pointer and then passes through the optical waveguide and processes the images to identify the position of the pointer on the optical waveguide surface based on the point(s) of escaped light for use as input to application programs.

Interactive input systems are useful during brainstorming sessions or meeting events held within an event room, such as for example a meeting room. Participants of such a session or event may be local or may join the session or event from remote locations. When the event room is not being used, room lights and other electrical devices, such as interactive boards and projectors, are typically powered off to conserve power. A computing device connected to the interactive board may automatically transition to a power saving “sleep state” after being inactive for a predefined period of time, or may transition to the sleep state upon receiving a user command to do so. Upon transitioning to the sleep state, documents and application programs that were previously open on the computing device are saved in memory, while peripheral devices attached to the computing device such as a hard disk, a display monitor, etc. are powered off.

Typically, event participants arrive in the event room close to the start time of the event. If the event room has not been in use for a while, the computing device connected to the interactive board may be in the sleep state, and the interactive board and the projector may be powered off. A user may give a command to the computing device, such as by pressing its power button, to power the computing device on. Upon being powered on, the computing device may command the interactive board to power on. It will be appreciated that it may take several minutes to fully power the interactive input system before the event can begin potentially resulting in a waste of valuable event time.

Wake-on-LAN (WOL) is an Ethernet computer networking standard that allows a destination computer to be turned on from a sleep state upon receiving a special network message sent by a remote computer such as a server. The special network message, referred to as a “magic packet”, comprises the media access control (MAC) address of the destination computer. The special network message may be used to wake up the computer in an event room before an event start time, and to prepare an interactive input system for an event, such as for example a meeting. As will be appreciated, implementation of the WOL approach requires centralized management of all event rooms from the remote computer. It also requires maintaining up-to-date records of the MAC addresses of all event room computers, so that the “magic packet” is sent to the correct computer before the event start time. In some business environments, such as a large corporate building, there may be dozens of event rooms, and it may be challenging to maintain up-to-date records of MAC addresses of all event room computers within the environment.

Some Microsoft Windows Operating Systems include a task scheduler component that is capable of performing tasks such as launching one or more programs, or waking up a computer from a sleep state, after one or more specified time intervals have passed.

There is generally a need for a method of waking up a computing device and preparing an interactive input system prior to an event, that does not require receiving a command or a message from a remote computer. It is therefore an object to provide a novel interactive input system and method.

### SUMMARY OF THE INVENTION

Accordingly, in one aspect there is provided a method of operating an interactive input system, comprising detecting user interaction with an interactive surface; acquiring schedule information from a scheduler; and transitioning said interactive input system to an operating mode according to at least one of said user interaction and said schedule information

In one embodiment, the operating mode is one of an off mode or on mode. The method may further comprise powering off an interactive board comprising the interactive surface in the off mode and conditioning a computing device communicating with the interactive board to a sleep state in the off mode. The method may further comprise initiating a timer operating in the computing device when the computing device is in the sleep state. In this case, the computing device wakes up upon expiry of the timer and transitions the interactive input system from the off mode to the on mode.

In one embodiment, the interactive input system may transition from the on mode to the off mode when no user interaction with the interactive surface is detected for a time period exceeding a threshold time period. The interactive system may transition from the on mode to the off mode when no event is scheduled within a threshold period of time. The interactive input system may transition from the on mode to the off mode in response to a user command.

In one embodiment, the on mode comprises a plurality of sub-modes. During transitioning of the interactive input system from the off mode to the on mode, the interactive input system transitions to a selected one of the sub-modes. In this case, the method may further comprise, in the selected sub-mode, displaying a user login screen. In the selected sub-mode, an event schedule populated with the acquired schedule information may also be displayed. The method may further comprise transitioning the interactive input system from the selected sub-mode to another sub-mode in response to user login. In this case, the method may further comprise, in the another sub-mode, executing an interactive collaboration application.

According to another aspect there is provided a method comprising in response to a timer, waking up a computing device in a sleep state that communicates with at least one interactive board in an operating environment and conditioning said computing device to acquire scheduling information for said operating environment; examining the scheduling information; and performing an action dependent on the scheduling information.

In one embodiment, performing an action comprises displaying acquired scheduling information on the interactive board or conditioning the computing device back to the sleep state. The displaying is performed when the scheduling information comprises an event that is scheduled to occur in the operating environment within a first threshold period of time from the current time. The conditioning is performed when the scheduling information comprises no event scheduled to occur within the first threshold period of time and may further comprise resetting the timer. When the scheduling information comprises an event scheduled to occur after the first threshold period of time but before a second threshold period of time, the timer is reset to wake the computing device up in advance of the event by a preset amount of time. When the scheduling information comprises no event scheduled to occur before the second threshold period of time, the timer is reset to wake the computing device up after a preset interval of time has elapsed.

According to yet another aspect there is provided an interactive input system comprising an interactive surface; and processing structure configured to detect user interaction with said interactive surface, communicate with a scheduler to acquire schedule information and transition said interactive input system to an operating mode according to at least one of said user interaction and said schedule information.

According to yet another aspect there is provided a computing device configured to operate a timer in a sleep state and to wake up in response to expiry of said timer, upon waking up, said computing device acquiring scheduling information for an operating environment and performing an action dependent on the acquired scheduling information.

### BRIEF DESCRIPTION OF THE DRAWINGS

Embodiments will now be described more fully with reference to the accompanying drawings in which:

FIG. 1 is a perspective view of an interactive input system;

FIG. 2 is a top plan view of an interactive board forming part of the interactive input system of FIG. 1 in an operating environment;

FIG. 3 is a schematic diagram showing operating modes of the interactive input system of FIG. 1;

FIG. 4A is a front view of the interactive board in an off mode;

FIG. 4B is a front view of the interactive board showing a user login screen displayed during an on_wait sub-mode;

FIG. 5 is a calendar widget application window displayed by the interactive board;

FIG. 6A is a front view of the interactive board in an on_interactive sub-mode;

FIG. 6B is a front view of the interactive board showing a locked screen displayed during the on_wait sub-mode;

FIGS. 7A and 7B are Microsoft Windows application programming interface (API) function codes used by the interactive input system of FIG. 1 for creating and setting, respectively, a waitable timer object;

FIGS. 8A and 8B are flowcharts showing steps in a method for determining an event schedule and for updating the operating mode of the interactive input system of FIG. 1;

FIG. 9A is a unified modelling language (UML) sequence diagram showing interaction between the interactive board, a general purpose computing device and a server forming part of the interactive input system of FIG. 1; and

FIG. 9B is a UML sequence diagram showing interaction between a login application, a calendar widget application, an event local service application and a scheduler application used by the interactive input system of FIG. 1.

### DETAILED DESCRIPTION OF THE EMBODIMENTS

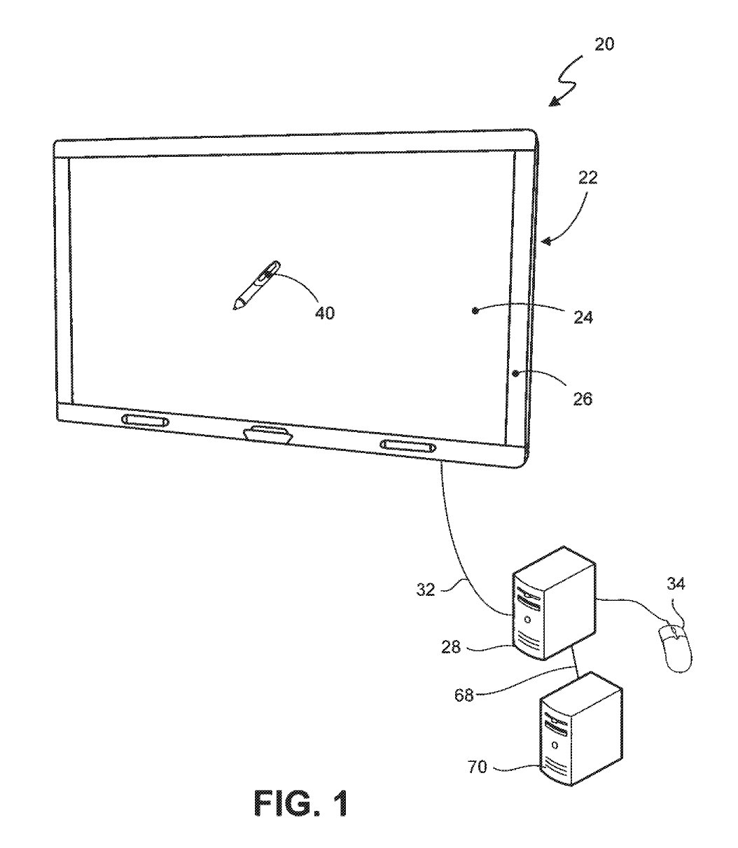

Turning now to FIG. 1, an interactive input system that allows a user to inject input such as digital ink, mouse events etc. into an executing application program is shown and is generally identified by reference numeral 20. In this embodiment, interactive input system 20 comprises an interactive board 22 mounted on a vertical support surface such as for example, a wall surface or the like or otherwise supported or suspended in an upright orientation. The interactive board 22 comprises a generally planar, rectangular interactive surface 24 that is surrounded about its periphery by a bezel 26. An image, such as for example a computer desktop is displayed on the interactive surface 24. In this embodiment, the interactive board 22 employs a liquid crystal display (LCD) panel or other suitable display device panel to present the images.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 32 or other suitable wired or wireless connection. General purpose computing device 28 processes the output of the interactive board 22 and adjusts image data that is output to the interactive board 22, if required, so that the image presented on the interactive surface 24 reflects pointer activity. In this manner, the interactive board 22 and general purpose computing device 28 allow pointer activity proximate to the interactive surface 24 to be recorded as writing or drawing or used to control execution of one or more application programs executed by the general purpose computing device 28.

Imaging assemblies (not shown) are accommodated by the bezel 26, with each imaging assembly being positioned adjacent a different corner of the bezel. Each of the imaging assemblies comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate.

The imaging assemblies are oriented so that their fields of view overlap and look generally across the entire interactive surface 24. In this manner, any pointer such as for example a user's finger, a cylinder or other suitable object, or a pen tool 40 or eraser tool that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey the image frames to a master controller (not shown) accommodated by the interactive board 22. The master controller in turn processes the image frames to determine the position of the pointer in (x,y) coordinates relative to the interactive surface 24 using triangulation. The pointer coordinates are then conveyed to the computing device 28 via cable 32 which uses the pointer coordinates to update the image displayed on the LCD panel if appropriate as described above.

The computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The computing device 28 may also comprise networking capability using Ethernet, WiFi, and/or other network format, for connection to access shared or remote drives, one or more networked computers, or other networked devices. The user may enter input or give commands to the computing device 28 through a mouse 34 or a keyboard (not shown). Other input techniques such as voice or gesture-based commands may also be used by the user to interact with the interactive input system 20.

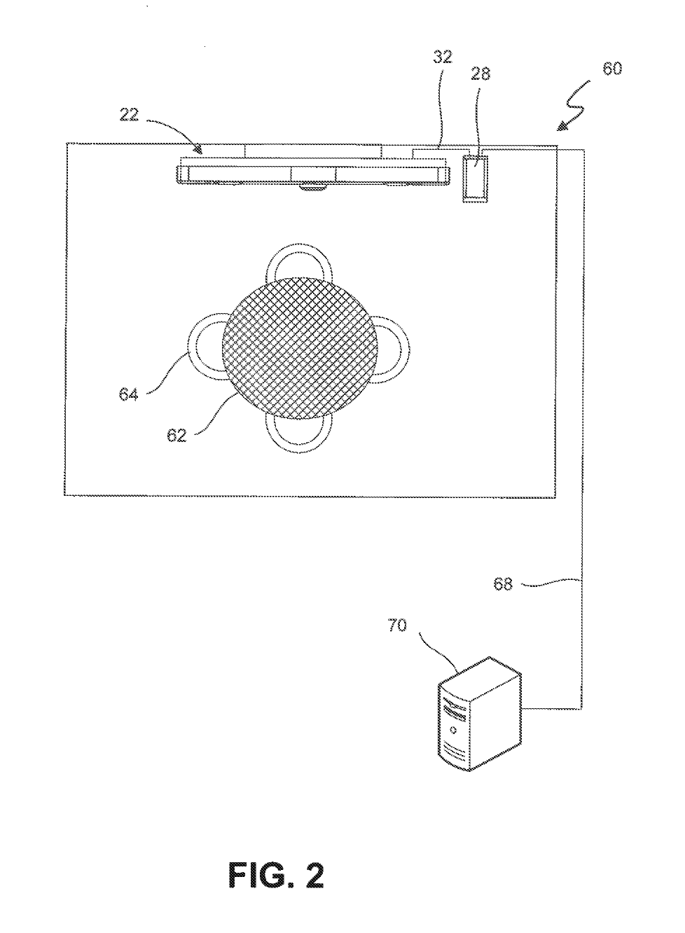

As shown in FIG. 2, interactive board 22 may operate in an operating environment 60 in which one or more fixtures 62 and 64 are located. In this embodiment, the operating environment 60 is a meeting room, fixture 62 is a table and fixtures 64 are chairs, however, as will be understood, interactive board 22 may be used in other environments. In this operating environment, computing device 28 is connected to a server 70, which may be located remotely, via a communication link 68 such as for example, a cable.

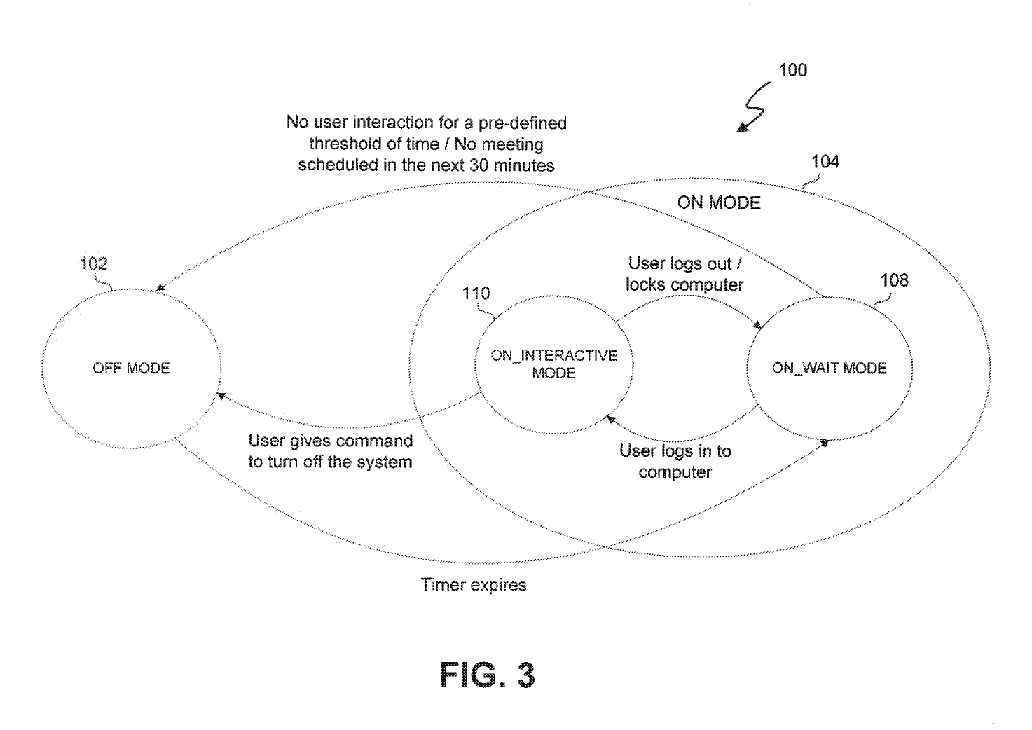

Interactive input system 20 has different operating modes, as schematically illustrated in FIG. 3. In this embodiment, the modes of operation comprise an off mode 102 and an on mode 104. In the off mode 102, the interactive board 22 is powered off, and the computing device 28 is in a sleep state. The sleep state of the computing device 28 corresponds to the S3 state of the G1 (sleeping) state, as defined in the Advanced Configuration and Power Interface (ACPI) specification. In this state, RAM memory of the computing device 28 remains powered on, and circuitry of the computing device 28 for recognizing, and responding to a “wake up” command also remains powered on.

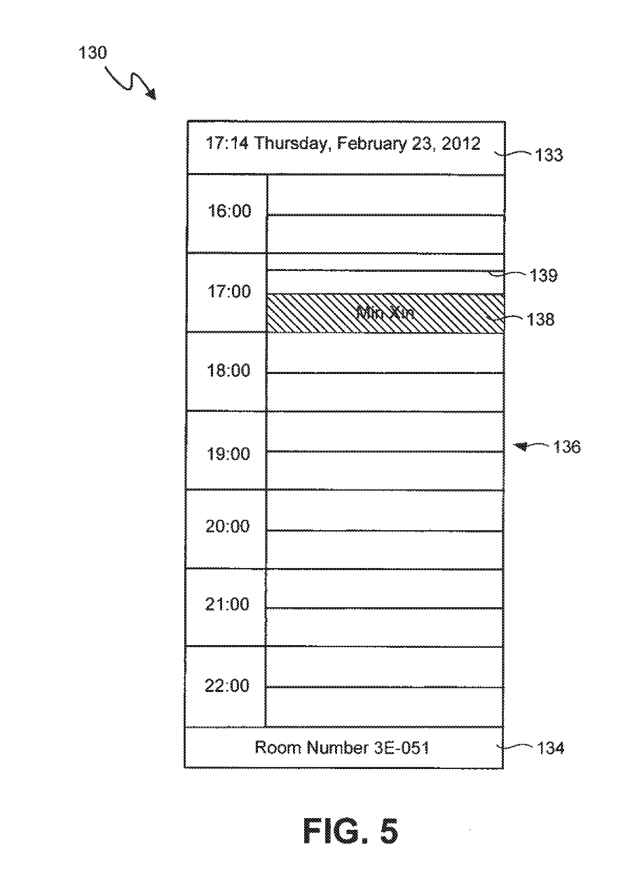

In the on mode 104, the computing device 28 is turned on, and the interactive board 22 is powered on. In this embodiment, the on mode 104 comprises a plurality of on sub-modes, in this case two on sub-modes, namely an on_wait sub-mode 108 and an on_interactive sub-mode 110. In the on_wait sub-mode 108, a calendar widget application program, developed by SMART Technologies ULC, runs on the computing device 28. The SMART calendar widget application program is configured to acquire event schedule data for the operating environment 60 from an event scheduler application running on the server 70 via a SMART event local service running on the computing device 28 and to display the event schedule data an in event schedule window 130 (see FIG. 5) on the interactive surface 24. In this embodiment, the event scheduler application is Microsoft Exchange. In the on_wait sub-mode 108, when a user logs into the computing device 28, the interactive input system 20 enters the on_interactive sub-mode 110. In this on sub-mode, the calendar widget application program is terminated by the computing device 28.

In the off mode 102, the computing device 28 while in the sleep state is configured to operate a computer timer. In this embodiment, the computer timer is a digital counter that decrements at a fixed frequency until expiry and is in the form of a waitable timer object. Waitable timer objects are known, and were introduced by Microsoft Corporation of Redmond, Wash. in the Windows 98 and Windows NT 4.0 operating systems. The waitable timer object can be set to expire at a specified time or at regular time intervals. Upon expiry, the waitable timer object can perform tasks, such as executing a function for transitioning a computing device from a sleep state to an on state. In this embodiment, the computing device 28 runs the Microsoft Windows 7 Operating System, and the waitable timer object is configured, using application programming interface (API) functions provided by that operating system, to wake up the computing device 28 at regular intervals as will be further described below.

When the waitable timer object is operating with the computing device 28 in the sleep state and the waitable timer object expires, it issues a “wake up” command, which causes the computing device 28 to wakeup and transition the interactive input system 20 from the off mode 102 to the on_wait sub-mode 108. When a user logs in to the computing device 28 when the interactive input system is in the on_wait mode 108, as described previously the computing device 28 causes the interactive input system 20 to transition from the on_wait mode 108 to the on_interactive sub-mode 110. The computing device 28 causes the interactive input system 20 to transition from the on_interactive sub-mode 110 back to the on_wait sub-mode 108 when the user logs out of the computing device 28 or locks the computing device 28. When the interactive input system 20 is in the on_interactive sub-mode 110, the user may give also a command to the computing device 28 to turn off the interactive input system 20, which causes the computing device 28 to transition the interactive input system 20 from the on_interactive mode 110 to the off mode 102. Also, when the interactive input system 20 is in the on_wait sub-mode 108 for a period of time exceeding a defined threshold, the computing device 28 transitions the interactive input system 20 from the on_wait sub-mode 108 to the off mode 102.

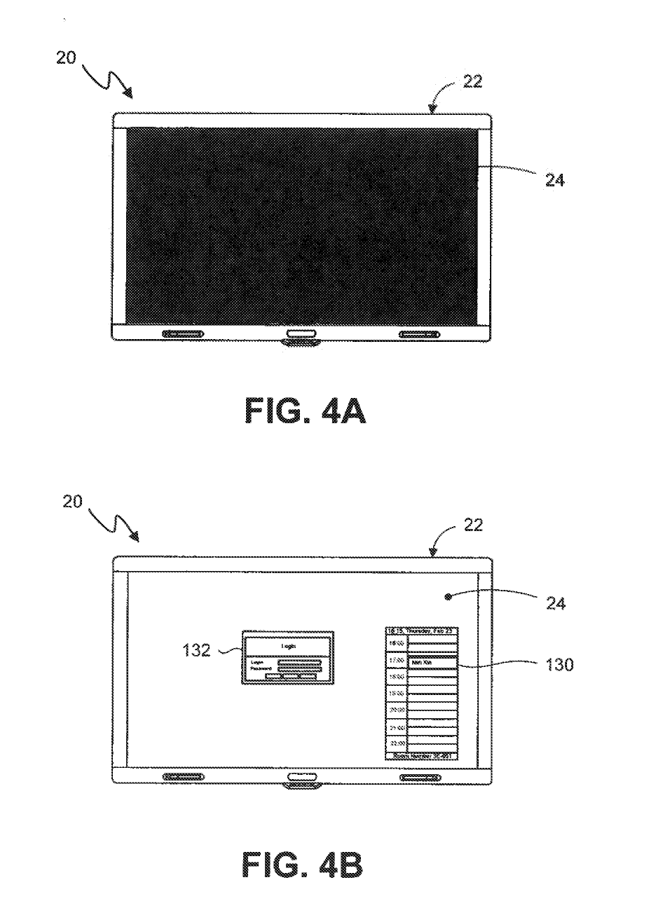

The computing device 28 is configured to execute a login application program when the interactive input system transitions from the off mode 102 to the on_wait sub-mode 108. In this embodiment, the login application program is configured using the Microsoft credential provider model forming part of the Microsoft Windows 7 Operating System and presents a login screen on the interactive surface 24 when executed. The credential provider model is a dynamic link library (DLL) that is configured to be executed whenever the login screen is presented during boot-up of the computing device 28, or when a user locks the computing device 28. The login screen comprises a login dialogue box 132 (see FIG. 4A) that includes fields to receive user credentials and allow the user to log in to the computing device 28. The login application program is also configured, using the credential provider model, to start the calendar widget application program. As mentioned previously, the SMART calendar widget application is configured to display the event schedule for the operating environment 60 in the event schedule window 130 on the interactive surface 24, when either the login dialogue box 132 is displayed or the computing device 28 is locked.

FIG. 4A shows the interactive board 22 when the interactive input system 20 is in the off mode 102. As can be seen, and as described above, in the off mode 102, the interactive board 22 is powered off, and nothing is displayed on the interactive surface 24. The computing device 28 is in the sleep state, and is operating the waitable timer object that is set to wake up the computing device 28 at intervals, in this example, every thirty (30) minutes.

FIG. 4B shows the interactive board 22 when the interactive input system 20 is in the on_wait sub-mode 108. As can be seen and as described above, in the on_wait sub-mode, the interactive board 22 is powered on. The computing device 28 is also turned on and is running the login application program, which displays the login dialogue box 132 on the interactive surface 24. The computing device 28 also runs the SMART calendar widget application, which displays the event schedule window 130 on the interactive surface 24.

The event schedule window 130 is better seen in FIG. 5. As can be seen, the event schedule window 130 comprises a field 133 in which the current time, the current date and the day of the week are displayed, and a field 134 in which a room number of the operating environment 60 is displayed. The event schedule window 130 also comprises an area 136 in which an event schedule for the operating environment 60 is displayed. In the embodiment shown, the displayed event schedule is over a seven (7) hour period, beginning at least one (1) hour prior to the current time. The event schedule displayed in the area 136 is populated with event schedule data acquired from the event scheduler application running on the server 70, and may comprise zero (0), one (1) or more than one (1) events. Each event shown in the event schedule is indicated as a coloured or shaded region 138, and comprises a start time, an end time and an owner of the event. The event schedule window 130 also comprises an indicator line 139 for indicating the current time. It will be understood that the display format of the event schedule window 130 is exemplary and that in other embodiments, the event schedule window may be displayed using another format.

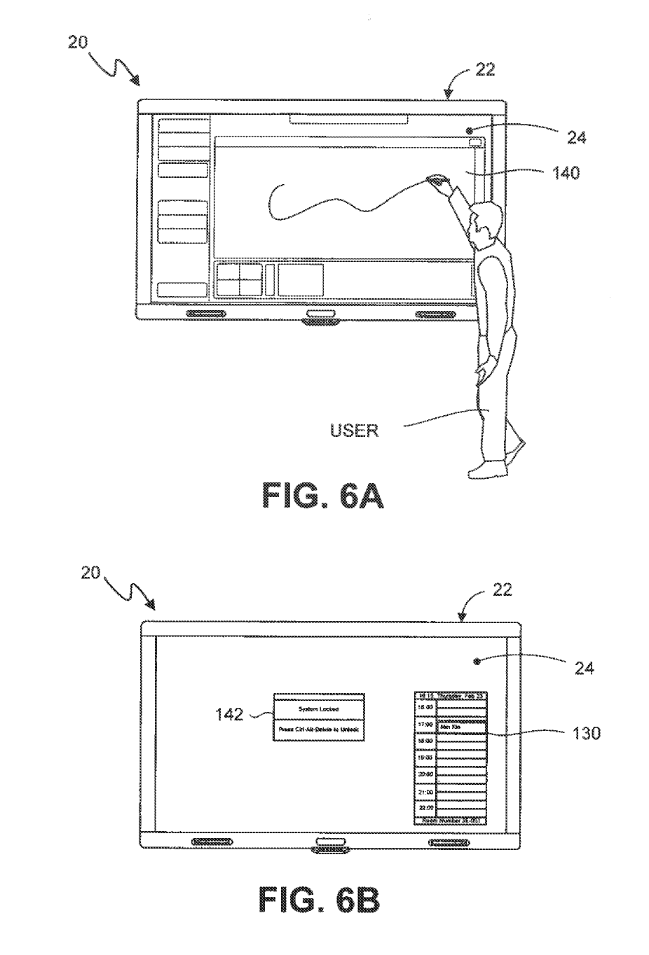

As mentioned previously, the computing device 28 transitions the interactive input system 20 from the on_wait sub-mode 108 to the on_interactive sub-mode 110 when a user enters valid login credentials into the login dialog box 132. FIG. 6A shows the interactive board 22 when the interactive input system 20 is in the on_interactive sub-mode 110. In the on_interactive sub-mode 110, the event schedule window 130 of the calendar widget application is not displayed on the interactive surface 24, and any instance of the SMART calendar widget application running on the computing device 28 is destroyed. However, in the on_interactive sub-mode 110, the computing device 28 is configured to run an interactive collaboration application. During running of the interactive collaboration application, a graphical user interface 140 is displayed on the interactive surface 24 of the interactive board 22 with which a user can interact. In this embodiment, the interactive collaboration application running on the computing device 28 is SMART Meeting Pro™ software developed by SMART Technologies ULC. It will however, be understood that other interactive collaboration applications may alternatively be used.

FIG. 6B shows the interactive board 22 when the interactive input system 20 is in the on_wait sub-mode 108, following a transition from the on_interactive sub-mode 110 as a result of the user locking the computing device 28. As can be seen, in the on_wait sub-mode 108, the SMART calendar widget application running on the computing device 28 displays the event schedule window 130 on the interactive surface 24. Additionally, the login application program running on computing device 28 presents a dialogue box 142 on the interactive surface 24. The dialogue box 142 comprises a message indicating that the computing device 28 is locked and providing instructions for unlocking the computing device 28. The computing device 28 is unlocked upon successful entry of login credentials by the user, which then causes the computing device 28 to transition the interactive input system 20 from the on_wait sub-mode 108 to the on_interactive sub-mode 110.

The SMART calendar widget application is configured to communicate with the SMART event local service in both scenarios of the on_wait sub-mode 108 shown in FIGS. 4B and 6B. In the scenario shown in FIG. 4B, in which no user has logged into the computing device 28, the SMART event local service is not running on the computing device 28. In this scenario, the SMART calendar widget application launches a Windows service via the login application program. The SMART calendar widget application connects to the server 70 through the Windows service to acquire the event schedule data for the operating environment 60. In the scenario shown in FIG. 6B, the SMART event local service running as the Windows service in the computing device 28 is stopped when a user logs in to the computing device 28. Another instance of the SMART event local service is then launched, which runs as a Windows application. This instance of the SMART event local service keeps running on the computing device 28 when the user locks the computing device 28, as shown in FIG. 6B. In this scenario, the SMART calendar widget application communicates with this instance of the event local service to acquire the event schedule data from the server 70.

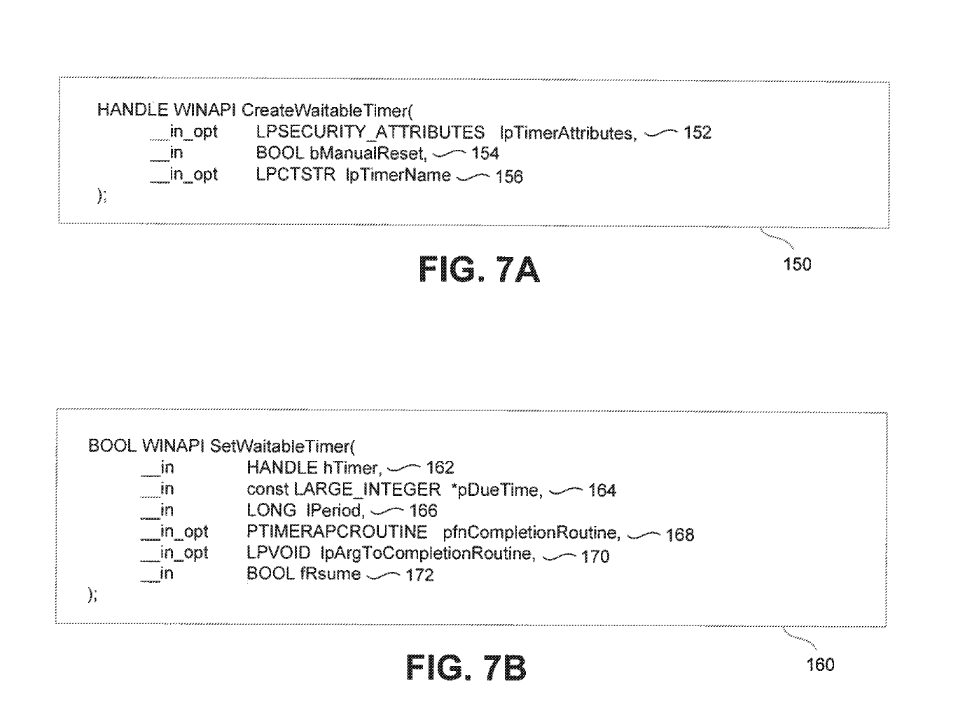

In this embodiment, the calendar widget application executes Microsoft Windows API functions to create the waitable timer object and to set the duration of the waitable timer object. FIG. 7A shows a Windows API function used by the interactive input system 20 for creating the waitable timer object, and which is generally indicated by reference numeral 150. The API function 150 comprises three (3) parameters 152, 154 and 156, with parameters 152 and 156 being optional. The parameter 152 is used for setting security attributes, and the parameter 156 is used for assigning a name to the waitable timer object. In the embodiment shown, the parameter 154 is set to “true”, which configures the waitable timer object as a manually reset timer. A manually reset timer remains in an expired state, also known in the art as a “signaled state”, until a SetWaitableTimer function is executed to set a new due time.

FIG. 7B shows a Windows API function used by the interactive input system 20 for setting the waitable timer object, and which is generally indicated by reference numeral 160. API function 160 effectively activates the waitable timer object after it has been created using the API function 150. The API function 160 comprises six (6) parameters 162, 164, 166, 168, 170 and 172, with parameters 168 and 170 being optional. The parameter 168 is used for passing a user-defined function, also known in the art as a “completion routine”, that is to be run upon expiry of the waitable timer object. The parameter 170 is used for passing a pointer to a data structure to the completion routine. The parameter 162 is used for identifying a handle to the waitable timer object. In this embodiment, the optional parameters 168 and 170 are not used. The parameter 164 is used to specify a time period after which the waitable timer object reaches the signaled state. The parameter 166 is used for designating the signalling frequency of the waitable timer object. If the value of the parameter 166 is set to zero, then the waitable timer object is signaled once, and if the value of the parameter 166 is set to a value greater than zero, then the waitable timer object is periodic. A periodic timer automatically reactivates the waitable timer object when the specified time period elapses. In this embodiment, the value of the parameter 166 is set to zero and the value of the parameter 172 is set to true, which initiates issuance of the “wake up” command when the waitable timer object expires.

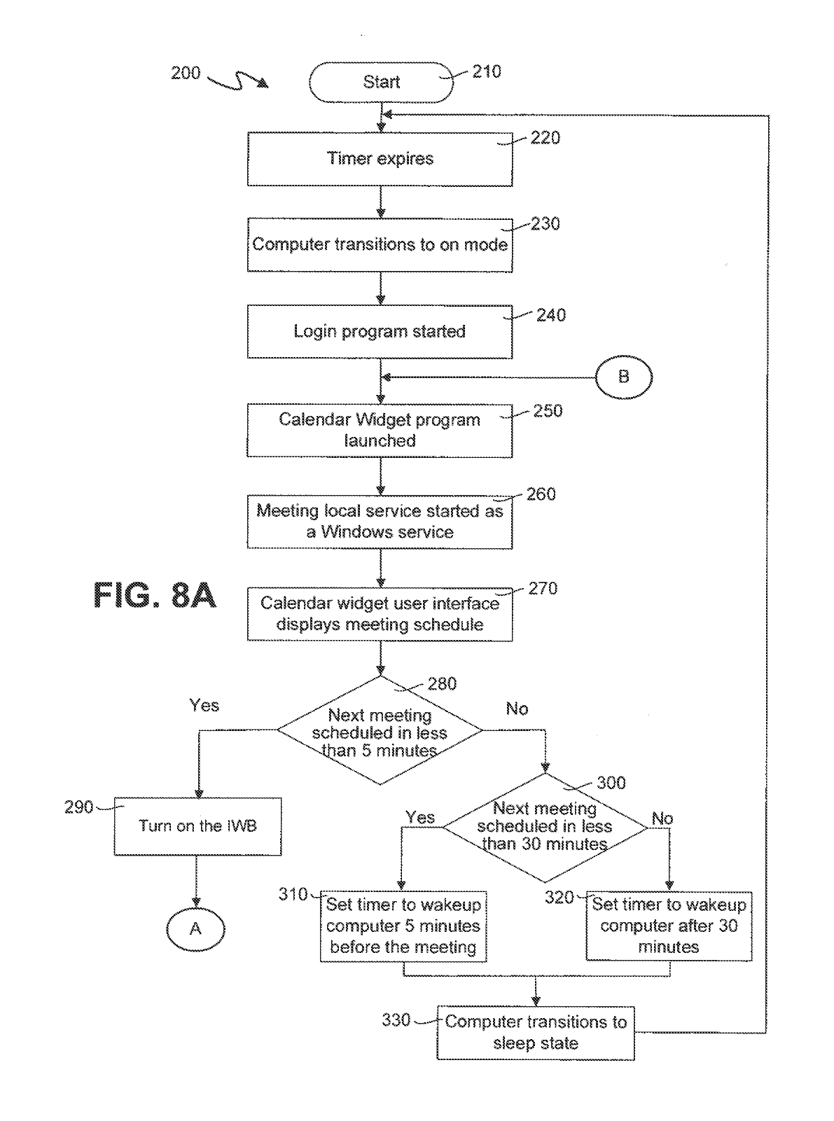

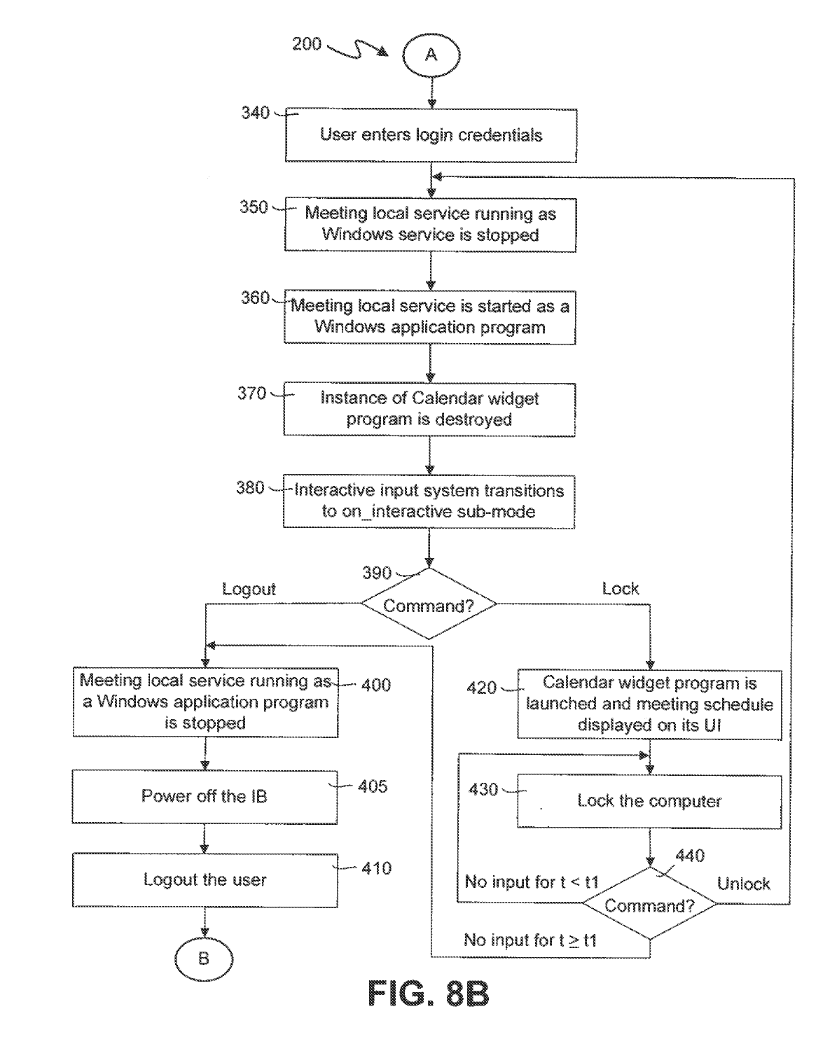

FIGS. 8A and 8B show steps performed by the interactive input system 20 for determining an event schedule and for updating the operating mode of the interactive input system 20, and which is generally indicated by reference numeral 200.

For the purpose of this explanation, initially it is assumed that the interactive input system 20 is in the off mode 102, the computing device 28 is in the sleep state and no user is logged into the computing device 28. When the waitable timer object operated by the computing device 28 expires (step 210), the waitable timer object issues a “wake up” command causing the computing device 28 to exit the sleep state and start the transition of the interactive input system 20 from the off mode 102 to the on_wait sub-mode 108 (step 230). During this step, the interactive board 22 remains powered off.

The computing device 28 then launches the user login application (step 240). The user login application then launches the SMART calendar widget application (step 250). The SMART calendar widget application then starts the SMART event local service as a Windows service (step 260). The event local service communicates with the server 70, which runs the event scheduler application, and acquires the event schedule data for the operating environment 60 in which the interactive board 22 is installed (step 270). The SMART event local service then communicates the acquired event schedule data to the SMART calendar widget application.

The SMART calendar widget application then checks to determine if an event is scheduled to occur in the operating environment 60 within the next five (5) minutes (step 280). If no event is scheduled to occur within the next five (5) minutes, then the SMART calendar widget application checks to determine if an event is scheduled to occur in the operating environment 60 within the next thirty (30) minutes (step 300). If an event is scheduled to occur within the next thirty (30) minutes, then the SMART calendar widget application sets the waitable timer object to wake up the computing device 28 a defined amount of time prior to the start of the scheduled event (step 310). In this embodiment, the predefined amount of time is five (5) minutes. If at step 300 no event is scheduled to occur within the next thirty (30) minutes, then the SMART calendar widget application sets the waitable timer to wake up the computing device 28 after thirty (30) minutes has elapsed (step 320). The computing device 28 then enters the sleep state, and the interactive input system 20 transitions from the on_wait sub-mode 108 to the off mode 102 (step 330).

If at step 280 an event is scheduled to occur within the next five (5) minutes, then the computing device 28 instructs the interactive board 22 to power on (step 290). During this step, and once the interactive board 22 has been powered on, the computing device 28 displays the login dialog box 132 and the event schedule window 130 on the interactive surface 24. Once the event schedule window 130 has been displayed, the transition of interactive input system 20 from the off mode 102 to the on_wait sub-mode 108 is complete. A user may then log into the computing device 28 by entering their login credentials (step 340). Upon successful login by a user, the SMART calendar widget application destroys the instance of the SMART event local service, which is currently running as a Windows service on the computing device 28 (step 350). The SMART calendar widget application then starts the SMART event local service as a Windows application program (step 360). The computing device 28 then destroys any instance of the SMART calendar widget application running thereon (step 370), which results in the event schedule window 130 no longer being displayed on the interactive surface 24. The computing device 28 then transitions the interactive input system 20 from the on_wait sub-mode 108 to the on_interactive sub-mode 110 (step 380).

Upon entering the on_interactive sub-mode 110, the computing device 28 launches the interactive collaboration application and displays its graphical user interface 140 on the interactive surface 24. The computing device 28 then awaits a command from the user (step 390). If the user inputs a logout command, then the computing device 28 stops the SMART event local service running thereon as a Windows application program (step 400), instructs the interactive board 22 to turn off (step 405), and logs the user out of the computing device 28 thereby to transition the interactive input system 20 from the on_interactive mode 110 to the off mode 102 (step 410). If at step 390, the user inputs a command to lock the computing device 28 to transition the interactive input system 20 from the on_interactive mode 110 to the on_wait mode 108, then the SMART calendar widget application is launched by the credential provider model, and the event schedule window 130 is displayed on the interactive surface 24 (step 420). The computing device 28 is then locked (step 430). While the computing device 28 is locked, the computing device 28 displays the dialog box 142 on the interactive surface 24. Once the computing device 28 has been locked, the transition of the interactive input system 20 from the on_interactive sub-mode 110 to the on_wait sub-mode 108 is complete.

While in the on_wait sub-mode 108, the computing device 28 awaits a command from a user (step 440). The computing device 28 monitors the duration of time, t, for which no command has been received, and compares the duration of time t to a threshold time period, t₁. In this embodiment, the value of threshold time period t₁ is five (5) minutes. If t<t₁, and a user enters login credentials at step 440, then the computing device 28 becomes unlocked and the method proceeds to step 350. Otherwise, if no command is received before the threshold time period t₁ is reached, then the computing device 28 initiates a logout command and the method proceeds to step 400.

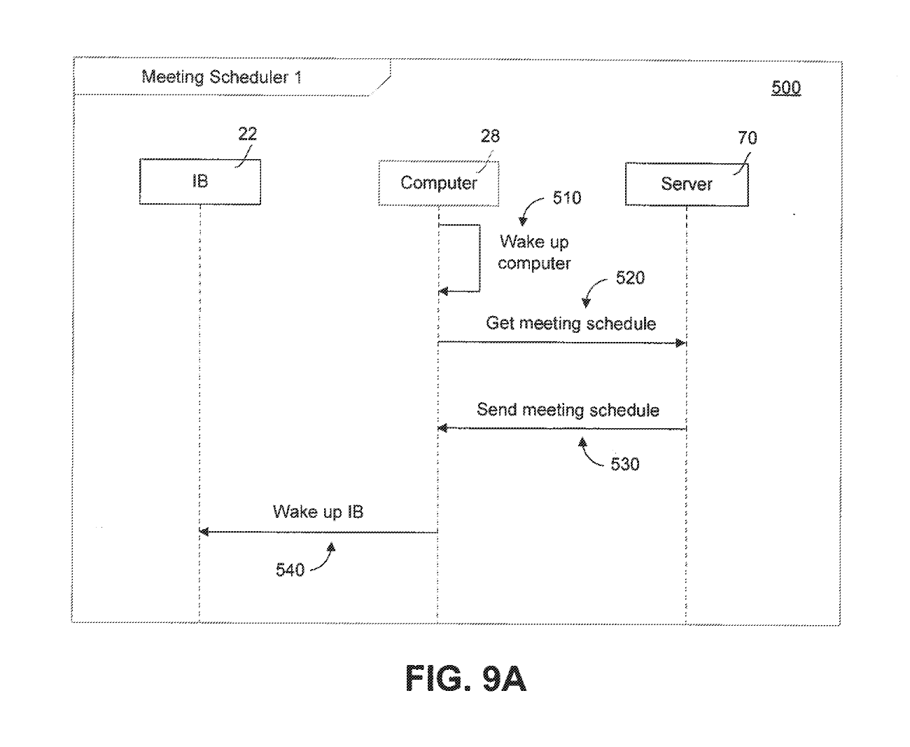

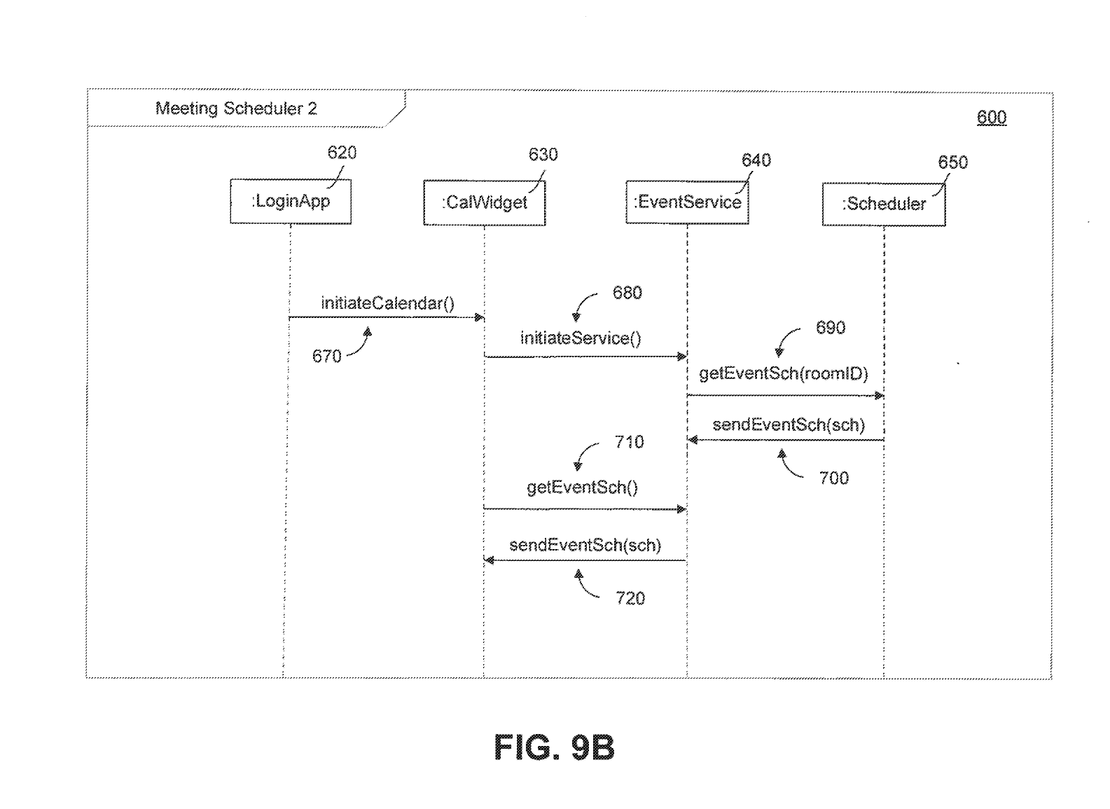

FIG. 9A shows interaction between the interactive board 22, the computing device 28 and the server 70, as a Unified Modeling Language (UML) sequence diagram, and which is generally referred to using reference numeral 500. When the waitable timer object expires, processing structure of the computing device 28 issues the “wake up” command by sending a message 510 to the computing device 28. After the computing device 28 wakes up, it sends a get event schedule message 520 to the server 70. In response, the server 70 sends the event schedule data, for the operating environment 60 in which the interactive board 22 is installed, to the computing device 28 in a send event schedule message 530. If an event is scheduled in the operating environment 60 within the next five (5) minutes, then computing device 28 instructs the interactive board 22 to power on by sending a wake up IB message 540 to the interactive board 22.

FIG. 9B shows interaction between software applications used by the interactive input system 20 and the server 70 as a UML sequence diagram, and which is generally referred to using reference numeral 600. Entities shown in rectangular boxes in UML sequence diagram 600 are instances, objects or services of the software applications running on the computing device 28 and on the server 70. An instance of a software application is created when instructions associated with the software application are loaded into memory of the computing device 28 or of the server 70 for execution. Similarly, the instance of the software application is destroyed when the instructions associated with the software application are removed from the memory of the computing device 28 or the server 70.

When the interactive input system 20 is in the on_wait sub-mode 108, and either the dialogue box 132 or dialogue box 142 is displayed, the Windows operating system launches the login application, and creates an instance LoginApp 620. Upon being launched, the login application is configured to launch the SMART calendar widget application, creating a CalWidget instance 630 via an initiateCalendar( ) message 670. The SMART calendar widget application creates a SMART event local service, EventService 640, via an initiateEventService( ) message 680. The EventService 640 runs as a Windows service, and not as a Windows application program, since no user is logged into the computing device 28. The EventService 640 sends a getEventSch(roomID) message 690 to the event scheduler service, Scheduler 650, that is running on the server 70. The Scheduler 650 returns the event schedule data for the operating environment 60 to the EventService 640 via a sendEventSch(sch) message 700.

The CalWidget 630 receives the event schedule data in a sendEventSch(sch) message 720, which is sent by EventService 640 in response to a getEventSch( ) request 710. The CalWidget 630 analyzes the event schedule data. The CalWidget 630 then executes the Windows API function 150 to create a waitable timer object, and executes the Windows API function 160 to set the waitable timer object.

In alternative embodiments, the computing device 28 may be connected to the world wide web via the Internet. In one such embodiment, the interactive board 22 may use a cloud-based brainstorming software application developed by SMART Technologies ULC for collaboration amongst the event participants as described in U.S. patent application Ser. No. 13/738,355 to Tse et al. filed on Jan. 11, 2012, and entitled “Method of Displaying Input During a Collaboration Session and Interactive Board Employing Same”, the disclosure of which is incorporated herein by reference in its entirety.

Although in embodiments described above, the computing device 28 instructs the interactive board 22 to power on if an event is scheduled to occur within five (5) minutes, in other embodiments, the computing device 28 may alternatively instruct the interactive board 22 to power on at a time closer to the scheduled event time or may not instruct the interactive board to power on in advance of the scheduled event time, in order to conserve power. In a related embodiment, the interactive board 22 may alternatively be transitioned into an intermediate state, sometimes referred to in the art as a “ready mode”, in which the interactive surface 24 of the interactive board 22 is dimmed. In one such embodiment, a small icon may be displayed on the interactive surface 24 to indicate that the interactive board 22 is in the intermediate state. In this case, the interactive board transitions to an interactive state when a user touches the icon. Operation of an interactive board in an intermediate state, and its transition to an interactive state, is described in U.S. patent application Ser. No. 13/524,752 to Tse et al. filed on Nov. 30, 2011 and entitled “Interactive Input System and Method”, the disclosure of which is incorporated herein by reference in its entirety.

Although in embodiments described above, the interactive input system is described as utilizing an LCD device for displaying images, those skilled in the art will appreciate that other types of display devices or arrangements for presenting images may be used. For example, a projector may be employed to project images on the interactive surface. The projector may project the images from behind the interactive surface or from in front of the interactive surface. In the latter form, the projector may be an ultra short-throw projector mounted on the wall surface above the interactive board 22 or may be a short-throw projector such as that sold by SMART Technologies ULC under the name “SMART UX60” that is mounted on a boom assembly extending outwardly from the wall surface.

In other embodiments, the computing device 28 may also be in communication with lighting and other electronic devices, such as other audio and visual equipment (e.g. a video camera and an audio system) in the operating environment. In this embodiment, in addition to powering on the interactive board, the computing device also powers on the lighting, the video camera and the audio system prior to the scheduled event in order to prepare the operating environment for the event.

In embodiments described above, the interactive board employs machine vision to detect user interaction with the interactive surface. Those of skill in the art will appreciate that interactive boards employing alternative technology to detect user interaction therewith may be employed. For example, interactive boards employing analog-resistive, capacitive, electromagnetic, acoustic etc. technologies to detect user interaction may be employed. Also, those skilled in the art will appreciate that the interactive board may take other orientations. For example, the interactive board may be in a generally horizontally orientation and form part of a touch table that is separate from or integrated into table fixture 62.

Although in embodiments described above, the computer timer is a digital counter that decrements at a fixed frequency until expiry, in other embodiments, the computer timer may alternatively be a digital counter that increments until reaching a target value.

The values for thresholds and time periods described above are exemplary. Those of skill in the art will appreciate that the values may be changed to suit the operating environment and/or user preference.

Although embodiments have been described above with reference to the accompanying drawings, those of skill in the art will appreciate that variations and modifications may be made without departing from the scope thereof as defined by the appended claims.

What is claimed is:

1. A method of operating an interactive input system, comprising:
detecting user interaction with an interactive surface;
acquiring schedule information from a scheduler; and
transitioning said interactive input system to an operating mode according to at least one of said user interaction and said schedule information.

2. The method of claim 1, wherein said operating mode is one of an off mode or an on mode.

3. The method of claim 2, further comprising powering off an interactive board comprising said interactive surface in said off mode.

4. The method of claim 3, further comprising conditioning a computing device communicating with said interactive board to a sleep state in said off mode.

5. The method of claim 4, further comprising initiating a timer operating in said computing device when said computing device is in said sleep state.

6. The method of claim 5, further comprising waking up said computing device upon expiry of said timer and transitioning the interactive input system from said off mode to said on mode.

7. The method of claim 6, wherein said timer is a waitable timer object executed by said computing device.

8. The method of claim 3, further comprising transitioning the interactive input system from said on mode to said off mode when no user interaction with said interactive surface is detected for a time period exceeding a threshold time period.

9. The method of claim 3, further comprising transitioning the interactive input system from said on mode to said off mode when no event is scheduled within a threshold time period.

10. The method of claim 3, further comprising transitioning the interactive input system from said on mode to said off mode in response to a user command.

11. The method of claim 3, wherein said on mode comprises a plurality of sub-modes.

12. The method of claim 11, wherein during transitioning of said interactive input system from said off mode to said on mode, the interactive input system transitions to a selected one of said sub-modes, said method further comprising, in said selected sub-mode, displaying a user login screen.

13. The method of 12, further comprising, in said selected sub-mode, displaying an event schedule populated with said acquired schedule information.

14. The method of claim 12, further comprising transitioning the interactive input system from the selected sub-mode to another sub-mode in response to user login, said method further comprising, in said another sub-mode, executing an interactive collaboration application.

15. The method of claim 13, wherein said event schedule is displayed on said interactive board and relates to an operating environment in which the interactive board is installed.

16. The method of claim 12, further comprising transitioning the interactive input system from said off mode to said selected sub-mode upon detecting user interaction with the interactive surface.

17. The method of claim 12, further comprising transitioning the interactive input system from said off mode to said selected sub-mode at a predefined time period before a scheduled event.

18. A method comprising:
in response to a timer, waking up a computing device in a sleep state that communicates with at least one interactive board in an operating environment and conditioning said computing device to acquire scheduling information for said operating environment;
examining the acquired scheduling information; and
performing an action dependent on the scheduling information.

19. The method of claim 18, wherein said performing an action comprises displaying acquired scheduling information on said interactive board or conditioning the computing device back to said sleep state.

20. The method of claim 19, wherein said displaying is performed when said scheduling information comprises an event that is scheduled to occur in said operating environment within a first threshold period of time from the current time.

21. The method of claim 20, wherein said conditioning is performed when said scheduling information comprises no events scheduled to occur within said first threshold period of time.

22. The method of claim 21, wherein said conditioning further comprises resetting said timer.

23. The method of claim 22, wherein when said scheduling information comprises an event scheduled to occur after said first threshold period of time but before a second threshold period of time, said timer is reset to wake said computing device up in advance of said event by a preset amount of time.

24. The method of claim 23, wherein when said scheduling information comprises no events scheduled to occur before said second threshold period of time, said timer is reset to wake said computing device after a preset interval of time has elapsed.

25. The method of claim 19, wherein upon waking up, said computing device conditions said interactive board to an on state.

26. The method of claim 19, wherein said computing device conditions said interactive board to an off state when said computing device is conditioned back to said sleep state.

27. An interactive input system comprising:
an interactive surface; and
processing structure configured to detect user interaction with said interactive surface, communicate with a scheduler to acquire schedule information and transition said interactive input system to an operating mode according to at least one of said user interaction and said schedule information.

28. The interactive input system of claim 27, wherein said operating mode is one of an off mode or an on mode.

29. The interactive input system of claim 28, further comprising an interactive board comprising said interactive surface, said processing structure powering off said interactive board in said off mode.

30. The interactive input system of claim 29, wherein said processing structure enters a sleep state in said off mode.

31. The interactive input system of claim 30, wherein said processing structure initiates a timer when in said sleep state, said processing structure waking up upon expiry of said timer and transitioning the interactive input system from said off mode to said on mode.

32. The interactive input system of claim 29, wherein said processing structure transitions the interactive input system from said on mode to said off mode when no user interaction with said interactive surface is detected for a period of time exceeding a threshold period of time.

33. The interactive input system of claim 29, wherein said processing structure transitions the interactive input system from said on mode to said off mode when no event is scheduled within a threshold period of time.

34. The interactive input system of claim 29, wherein said processing structure transitions the interactive input system from said on mode to said off mode in response to a user command.

35. The interactive input system of claim 29, wherein said on mode comprises a plurality of sub-modes.

36. The interactive input system of claim 35, wherein said processing structure, during transitioning of said interactive input system from said off mode to said on mode, transitions the interactive input system to a selected one of said sub-modes and wherein in said selected sub-mode, said interactive surface displays a user login screen.

37. The interactive input system of claim 36, wherein in said selected sub-mode, an event schedule populated with said acquired schedule information is displayed on said interactive surface.

38. The interactive input system of claim of claim 36, wherein said processing structure transitions the interactive input system from the selected sub-mode to another sub-mode in response to user login and wherein in said another sub-mode, said processing structure executes an interactive collaboration application.

39. A computing device configured to operate a timer in a sleep state and to wake up in response to expiry of said timer, upon waking up, said computing device acquiring scheduling information for an operating environment and performing an action dependent on the acquired scheduling information.

40. The computing device of claim 39, wherein said computing device, during said performing, either displays the acquired scheduling information on an interactive board or conditions itself back to a sleep state.

41. The computing device of claim 40, wherein said computing device performs said displaying when said scheduling information comprises an event that is scheduled to occur in said operating environment within a threshold period of time from the current time.

42. The computing device of claim 41, wherein said computing device conditions itself back to sleep when said scheduling information comprises no events scheduled to occur within said first threshold period of time.

43. The computing device of claim 33, wherein said computing device, during conditioning itself back to sleep, resets said timer.

44. The computing device of claim 43, wherein when said scheduling information comprises an event scheduled to occur after said first threshold period of time but before a second threshold period of time, said computing device resets said timer to wake said computing device up in advance of said event by a preset amount of time.

45. The computing device of claim 44, wherein when said scheduling information comprises no events scheduled to occur before said second threshold period of time, said computing device resets said timer to wake said computing device after a preset interval of time has elapsed.

46. The computing device of claim 39, wherein upon waking up, said computing device conditions an interactive board to an on state.

47. The computing device of claim 39, wherein said computing device conditions an interactive board to an off state when said computing device is conditioned back to said sleep state.
